(19) United States
(12) Patent Application Publication
(10) Pub. No.: US 2021/0276264 A1
(43) Pub. Date: Sep. 9, 2021

(54) BUILD MATERIAL PARTICLE OPTICAL PROPERTY IDENTIFICATION

(71) Applicants: OREGON STATE UNIVERSITY, Corvallis, OR (US); HEWLETT-PACKARD DEVELOPMENT COMPANY, L.P., Spring, TX (US)

(72) Inventors: David A. Champion, Corvallis, OR (US); Daniel Mosher, Corvallis, OR (US); Brian Bay, Corvallis, OR (US)

(21) Appl. No.: 16/608,354

(22) PCT Filed: Mar. 23, 2018
(86) PCT No.: PCT/US2018/024176

§ 371 Date: Oct. 25, 2019

(51) Int. Cl. B29C 64/393; B29C 67/00

(52) U.S. Cl. CPC B29C 64/393; B29K 2105/0032; B29C 67/0007

(57) ABSTRACT

According to examples, an apparatus may include a processor and a memory on which are stored machine-readable instructions that when executed by the processor, cause the processor to access a stereoscopic three-dimensional (3D) image of a layer including solidified build material particles. The instructions may also cause the processor to identify an optical property of the solidified build material particles at a location on the layer from the stereoscopic 3D image. The instructions may further cause the processor to determine whether the identified optical property exceeds a predefined threshold and based on a determination that the identified optical property exceeds the predefined threshold, output an indication that the layer includes an optical property that exceeds the predefined threshold.

### BACKGROUND

In three-dimensional (3D) printing, an additive printing process may be used to make three-dimensional solid parts from a digital model. Some 3D printing techniques are considered additive processes because they involve the application of successive layers or volumes of a build material, such as a powder or powder-like build material, to an existing surface (or previous layer). 3D printing often includes solidification of the build material, which for some materials may be accomplished through use of heat and/or a chemical binder.

### BRIEF DESCRIPTION OF THE DRAWINGS

Features of the present disclosure are illustrated by way of example and not limited in the following figure(s), in which like numerals indicate like elements, in which:

FIG. 1 shows an example apparatus that may identify an optical property in solidified build material particles in a layer using a stereoscopic 3D image of the layer;

FIG. 2 shows a diagram of an example 3D fabrication system in which the apparatus depicted in FIG. 1 may be implemented;

FIG. 3 depicts an example stereoscopic 3D image of a layer of build material particles including a location having an unintended optical property;

FIGS. 4 and 5, respectively, show flow diagrams of example methods for outputting at least one of an alert or an instruction to correct a condition in solidifying build material particles; and

FIG. 6 shows an example 3D fabrication system that may be used to implement either or both of the methods depicted in FIGS. 4 and 5.

### DETAILED DESCRIPTION

For simplicity and illustrative purposes, the present disclosure is described by referring mainly to examples. In the following description, numerous specific details are set forth in order to provide a thorough understanding of the present disclosure. It will be readily apparent however, that the present disclosure may be practiced without limitation to these specific details. In other instances, some methods and structures have not been described in detail so as not to unnecessarily obscure the present disclosure.

Throughout the present disclosure, the terms “a” and “an” are intended to denote at least one of a particular element. As used herein, the term “includes” means includes but not limited to, the term “including” means including but not limited to. The term “based on” means based at least in part on.

Disclosed herein are apparatuses, methods, and 3D fabrication systems for identifying an optical property of build material particles and for outputting an instruction to correct a condition in solidifying build material particles in a current and/or future layer, e.g., a next layer, and/or outputting an indication regarding the identified optical property. Particularly, for instance, a processor as disclosed herein may access a stereoscopic three-dimensional (3D) image of a layer, in which the layer includes build material particles that have been solidified (e.g., melted and fused, binded together using a binding agent, and/or the like). The processor may identify an optical property of the solidified build material particles at a location on the layer from the stereoscopic 3D image. The optical property of the solidified build material particles may be an optical property that matches a predefined optical property. The optical property may be a color, a transparency, a brightness, a glossiness, and/or the like, of the solidified build material particles.

The processor may determine whether the identified optical property exceeds a predefined threshold and based on a determination that the identified optical property exceeds the predefined threshold, the processor may output an indication that the layer includes an optical property that exceeds the predefined threshold. In some examples, the processor may determine that the identified optical property exceeds the predefined threshold based on the identification of the optical property itself. In any regard, the processor may output the indication such that, for instance, an operator may be notified of the existence of areas on the current layer having the identified optical property and/or that the identified optical property of the areas exceeds a predefined threshold.

The identified optical property may be indicative of any of various conditions of the solidified build material particles. That is, the solidified build material particles may obtain various optical properties depending upon various factors under which the build material particles were solidified. For instance, some of the build material particles may turn a particular color or have some other optical property when the build material particles are solidified in the presence of a certain amount of oxygen and/or moisture. As another example, some of the build material particles may turn a particular color or have some other optical property when the build material particles receive a certain amount of energy during or following a solidifying operation. The factors under which the build material particles were solidified may affect a quality, e.g., strength, appearance, defect, or the like of the solidified build material particles. Thus, for instance, the existence of an identified optical property on some solidified build material particles may be an indication that a defect may exist in the solidified build material particles. According to examples, the processor may identify these optical properties and may determine a likely cause for the occurrence of these optical properties. In addition, based on the determined likely cause, the processor may output an indication and/or modify a solidifying operation implemented on a current or future layer of build material particles.

As noted herein, the processor may identify the optical properties from a stereoscopic 3D image of the layer of build material particles. The stereoscopic 3D image may include height information of the build material particles. In this regard, the processor may also identify the heights of the regions of solidified build material particles having the identified optical property. The processor may also use the identified heights of the build material particles in determining a likely cause for the occurrence of the optical properties. For instance, the processor may correlate the build material particles having the identified optical property with a relative z-position of the build material particles in order to determine the likely cause of the build material particles to have the identified optical property.

Through implementation of the apparatuses, methods, and 3D fabrications systems disclosed herein, a determination as to whether solidified build material particles may include a possible defect may be made in a relatively quick and efficient manner through analysis of a stereoscopic 3D image. In one regard, the determination may be made during fabrication of a 3D object and without destroying or otherwise harming the 3D object being fabricated. In another regard, the determination may be made during fabrication and thus, if a possible defect is determined, a corrective action may be taken to prevent the possible defect from occurring in future layers of build material particles. In addition, if the defect is sufficiently severe and/or within a region corresponding to the 3D object being generated, an operator may stop fabrication of the 3D object, which may result in a reduction in wasted build material particles and time in fabricating a defective 3D object. Thus, for instance, if the defect is outside of a region corresponding to the 3D object being generated, fabrication of the 3D object may be continued.

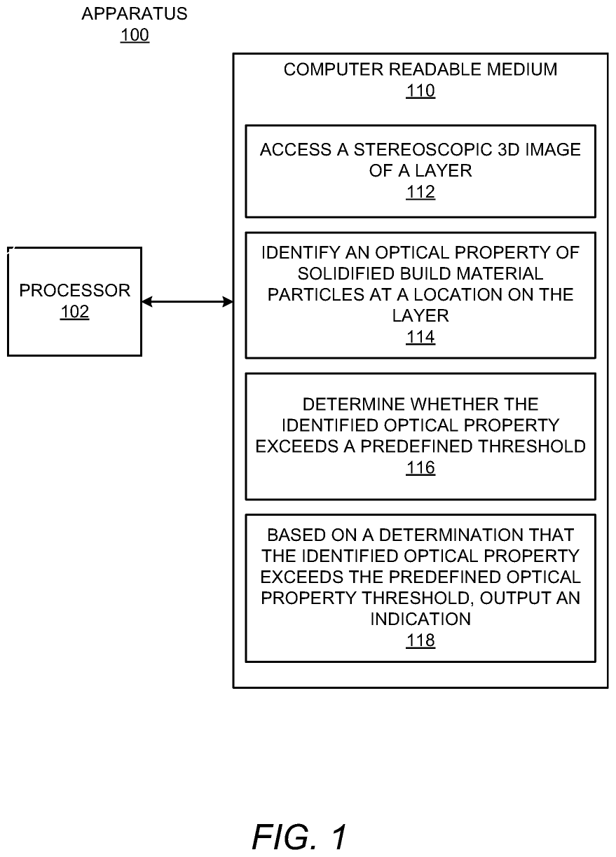

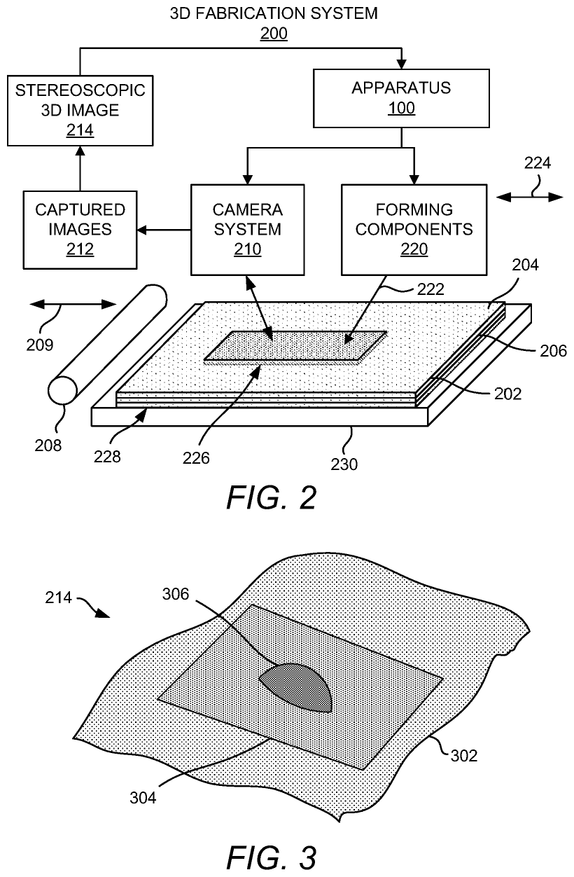

Reference is made first to FIGS. 1 and 2. FIG. 1 shows a block diagram of an example apparatus 100 that may identify of an optical property in solidified build material particles in a layer using a stereoscopic 3D image of the layer. FIG. 2 shows a diagram of an example 3D fabrication system 200 in which the apparatus 100 depicted in FIG. 1 may be implemented. It should be understood that the example apparatus 100 depicted in FIG. 1 and the example 3D fabrication system 200 depicted in FIG. 2 may include additional features and that some of the features described herein may be removed and/or modified without departing from the scopes of the apparatus 100 or the 3D fabrication system 200.

The apparatus 100 may be a computing device, a tablet computer, a server computer, a smartphone, or the like. The apparatus 100 may also be part of a 3D fabrication system 200, e.g., a control system of the 3D fabrication system 200. Although a single processor 102 is depicted, it should be understood that the apparatus 100 may include multiple processors, multiple cores, or the like, without departing from a scope of the apparatus 100.

The 3D fabrication system 200, which may also be termed a 3D printing system, a 3D fabricator, or the like, and may be implemented to fabricate 3D objects through selectively solidifying of build material particles 202, which may also be termed particles 202 of build material. In some examples, the 3D fabrication system 200 may use energy, e.g., in the form of light and/or heat, to selectively melt and fuse the particles 202. In addition or in other examples, the 3D fabrication system 200 may use binding agents to selectively bind or solidify the particles 202. In particular examples, the 3D fabrication system 200 may use fusing agents that increase the absorption of energy to selectively fuse the particles 202.

According to one example, a suitable fusing agent may be an ink-type formulation including carbon black, such as, for example, the fusing agent formulation commercially known as V1Q60Q “HP fusing agent” available from HP Inc. In one example, such a fusing agent may additionally include an infra-red light absorber. In one example such fusing agent may additionally include a near infra-red light absorber. In one example, such a fusing agent may additionally include a visible light absorber. In one example, such a fusing agent may additionally include a UV light absorber. Examples of fusing agents including visible light enhancers are dye based colored ink and pigment based colored ink, such as inks commercially known as CE039A and CE042A available from HP Inc. According to one example, the 3D fabrication system 200 may additionally use a detailing agent. According to one example, a suitable detailing agent may be a formulation commercially known as V1Q61A “HP detailing agent” available from HP Inc.

The build material particles 202 may include any suitable material for use in forming 3D objects. The build material particles 202 may include, for instance, a polymer, a plastic, a ceramic, a nylon, a metal, combinations thereof, or the like, and may be in the form of a powder or a powder-like material. Additionally, the build material particles may be formed to have dimensions, e.g., widths, diameters, or the like, that are generally between about 5 μm and about 100 μm. In other examples, the particles may have dimensions that are generally between about 30 μm and about 60 μm. The particles may have any of multiple shapes, for instance, as a result of larger particles being ground into smaller particles. In some examples, the particles may be formed from, or may include, short fibers that may, for example, have been cut into short lengths from long strands or threads of material. In addition or in other examples, the particles may be partially transparent or opaque. According to one example, a suitable build material may be PA12 build material commercially known as V1R10A “HP PA12” available from HP Inc.

As shown in FIG. 1, the apparatus 100 may include a processor 102 that may control operations of the apparatus 100. The processor 102 may be a semiconductor-based microprocessor, a central processing unit (CPU), an application specific integrated circuit (ASIC), a field-programmable gate array (FPGA), and/or other suitable hardware device. The apparatus 100 may also include a memory 110 that may have stored thereon machine readable instructions 112-118 (which may also be termed computer readable instructions) that the processor 102 may execute. The memory 110 may be an electronic, magnetic, optical, or other physical storage device that contains or stores executable instructions. The memory 110 may be, for example, Random Access memory (RAM), an Electrically Erasable Programmable Read-Only Memory (EEPROM), a storage device, an optical disc, and the like. The memory 110, which may also be referred to as a computer readable storage medium, may be a non-transitory machine-readable storage medium, where the term “non-transitory” does not encompass transitory propagating signals.

The processor 102 may fetch, decode, and execute the instructions 112 to access a stereoscopic 3D image 214 of a surface 204 of a layer 206 of build material particles 202. The 3D fabrication system 200 may include a spreader 208 that may spread the build material particles 202 into the layer 206, e.g., through movement across a platform 230 as indicated by the arrow 209. A stereoscopic 3D image 214 may be created from two offset images 212 of the layer surface 204 to give the perception of 3D depth. As shown in FIG. 2, the 3D fabrication system 200 may include a camera system 210 to capture the offset images 212.

The camera system 210 may include a single camera or multiple cameras positioned at different angles with respect to each other such that multiple ones of the captured images 212 may be combined to generate stereoscopic 3D images. According to examples, the camera system 210 may capture high-resolution images, e.g., high definition quality, 4K resolution quality, or the like, such that the stereoscopic 3D images generated from images captured by the camera system 210 may also be of high resolution. In addition, the 3D fabrication system 200 may include a light source (not shown) to illuminate the layer surface 204 and enable the camera system 210 to capture fine details in the layer surface 204.

The processor 102 may control the camera system 210 to capture multiple images 212 of the layer surface 204 and the stereoscopic 3D image 214 may be generated from the multiple captured images 212. For instance, the camera system 210 may have been controlled to capture a first image of the layer surface 204 from a first angle with respect to the layer surface 204 and may have been controlled to capture a second image of the layer surface 204 from a second, offset, angle with respect to the layer surface 204. In addition, the first image may have been combined with the second image to create the stereoscopic 3D image 214. For instance, the first image and the second image may be combined via a pixel-wise comparison of trackable features in the first image and trackable features in the second image. In some examples, a first camera of the camera system 210 may have captured the first image and a second camera of the camera system 210 may have captured the second image. In other examples, a single camera of the camera system 210 may have captured the first image and may have been moved or otherwise manipulated, e.g., through use of mirrors and/or lenses, to capture the second image.

The camera system 210 may generate the stereoscopic 3D image 214 from the multiple captured images and may communicate the generated stereoscopic 3D image 214 to the processor 102 or to a data store from which the processor 102 may access the stereoscopic 3D image 214 of the layer surface 204. In other examples, the camera system 210 may store the captured images in a data store (not shown) and the processor 102 may generate the stereoscopic 3D image 214 of the layer surface 204 from the stored images.

As also shown in FIG. 2, the 3D fabrication system 200 may include forming components 220 that may output energy/agent 222 onto the layer 206 as the forming components 220 are scanned across the layer 206 as denoted by the arrow 224. The forming components 220 may also be scanned in the direction perpendicular to the arrow 224 or in other directions. In addition, or alternatively, a platform 230 on which the layers 206 are deposited may be scanned in directions with respect to the forming components 220.

The fabrication system 200 may include a build zone 228 within which the forming components 220 may solidify the build material particles 202 in a selected area 226 of the layer 206. The selected area 226 of a layer 206 may correspond to a section of a 3D object being fabricated in multiple layers 206 of the build material particles 202. The forming components 220 may include, for instance, an energy source, e.g., a laser beam source, a heating lamp, or the like, that may apply energy onto the layer 206 and/or that may apply energy onto the selected area 226. In addition or alternatively, the forming components 220 may include a fusing agent delivery device to selectively deliver a fusing agent onto the build material particles 202 in the selected area 226, in which the fusing agent enhances absorption of the energy to cause the build material particles 202 upon which the fusing agent has been deposited to melt. The fusing agent may be applied to the build material particles 202 prior to application of energy onto the build material particles 202. In other examples, the forming components 220 may include a binding agent delivery device that may deposit a binding agent, such as an adhesive that may bind build material particles 202 upon which the binding agent is deposited.

The solidified build material particles 202 may equivalently be termed fused build material particles, bound build material particles, or the like. In any regard, the solidified build material particles 202 may be a part of a 3D object, and the 3D object may be built through selective solidifying of the build material particles 202 in multiple layers 206 of the build material particles 202.

In some examples, the captured images 212 used to create the stereoscopic 3D image 214 of the layer 206 may have been captured prior to a solidifying operation being performed on the layer 206 of build material particles 202. In other examples, the captured images 212 used to create the stereoscopic 3D image 214 may have been captured following a solidifying operation being performed on the layer 206. In these examples, the stereoscopic 3D image 214 may have been created from images 212 that include both build material particles 202 in the selected area 226 of the layer 206 that have been solidified together and build material particles 202 that have not been solidified together. In still other examples, the camera system 210 may continuously capture images, e.g., video, and the continuously captured images may be used to continuously create multiple stereoscopic 3D images, e.g., video.

The processor 102 may fetch, decode, and execute the machine-readable instructions 114 to identify an optical property of the solidified build material particles 202 at a location on the layer 206 from the stereoscopic 3D image 214. The optical property may include, for instance, a color, a transparency, a brightness, a glossiness, and/or the like. For instance, the processor 102 may analyze the stereoscopic 3D image 214 to identify the optical property of the solidified build material particles at a location on the layer 206 or across the layer 206. In addition, the processor 102 may determine whether the determined optical property matches a predefined optical property. For instance, the processor 102 may analyze the stereoscopic 3D image 214 of the layer 206 for any locations on the layer 206 at which the optical property of the build material particles 202 matches one of the predefined optical properties. The processor 102 may also identify the location or locations at which the build material particles 202, e.g., the solidified build material particles 202, have an optical property that matches a predefined optical property.

As discussed herein, the predefined optical properties may correspond to various characteristics of the solidified build material particles. By way of example in which the build material particles 202 are metal powder and the optical property is color, the predefined colors may be red, orange, green, blue, etc. In this example, a red or orange color may indicate the presence of excess oxygen or water that may cause a buildup of oxidation (e.g., rust) on the fused build material particles 202. In addition, a blue or green color may indicate that excess heat was applied to the build material particles 202 during fusing of the build material particles 202.

Although particular reference is made herein to the stereoscopic 3D image 214 being a color image, it should be understood that the stereoscopic 3D image 214 of the layer may equivalently be a greyscale stereoscopic 3D image, in which different optical properties of the fused build material particles 202 may be represented in greyscale. As such, the processor 102 may analyze the stereoscopic 3D image 214 of the layer 206 for any locations on the layer 206 at which the greyscale value of the solidified build material particles 202 matches one of predefined greyscale values. The processor 102 may also identify the location or locations at which the solidified build material particles 202 have greyscale values that match the predefined optical properties. Similarly to the predefined optical properties, e.g., colors, discussed herein, the predefined greyscale values may correspond to various characteristics of the solidified build material particles 202. For instance, a darker color may correspond to a larger possible defect than a lighter color. Accordingly, references made herein to optical properties may also be understood as being directed to greyscale values. In addition, the visualization of the stereoscopic 3D image 214 may be modified such that a false color may be added to the areas that have been identified as potentially being defective to enable those areas to be distinguished from the other areas in the stereoscopic 3D image 214.

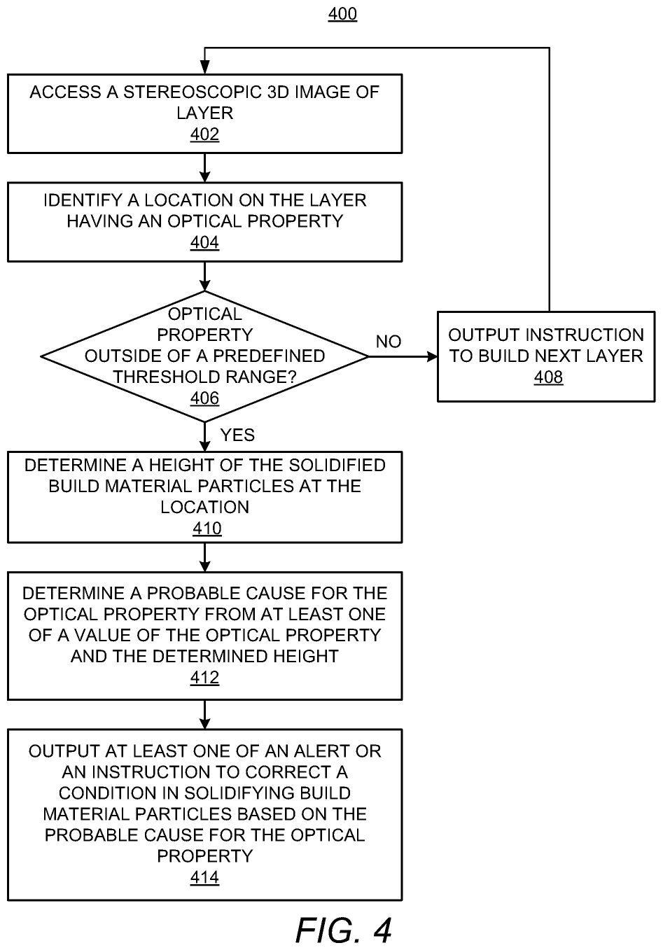

An example stereoscopic 3D image 214 of a layer 206 having an unintended optical property is depicted in FIG. 3. It should be understood that FIG. 3 merely depicts an example and should thus not be construed as limiting the present disclosure to the features depicted in that figure. In FIG. 3, the stereoscopic 3D image 214 may include a first area 302 that may have a first optical property, e.g., build material particles 202 that have not been solidified together. In addition, the stereoscopic 3D image 214 may include a second area 304, e.g., an area of solidified build material particles 202, that may have a second optical property, e.g., an intended optical property (an intended color, an intended brightness, etc.). The stereoscopic 3D image 214 may also include a third area 306, e.g., an area of solidified build material particles 202, having a third optical property. The third optical property may be an unintended optical property, e.g., an optical property that corresponds to a defect or other state of the solidified build material particles 202.

As the stereoscopic 3D image 214 of the layer 206 may have greater detail than a 2D image of the layer 206, the processor 102 may identify characteristics of the build material particles 202 in the layer 206 in addition to optical properties from the stereoscopic 3D image 214. The characteristics may include the heights or depths of the build material particles 202 in the layer 206. Thus, for instance, the processor 102 may identify the heights or depths of the build material particles 202 having the identified optical properties. The processor 102 may use the identified heights or depths in, for instance, determining a likely cause of the build material particles 202 having the identified optical property. By way of example, the processor 102 may use the identified height of the third area 306 to determine a likely cause of the build material particles 202 in the third area 306 having the identified optical property.

The processor 102 may fetch, decode, and execute the machine-readable instructions 116 to determine whether the identified optical property exceeds a predefined threshold. According to examples, the predefined threshold may be exceeded when the optical property is determined to be present in the stereoscopic 3D image 214. That is, the processor 102 may determine that the identified optical property exceeds the predefined threshold based on the processor 102 identifying the existence of the optical property in the solidified build material particles 202. In other examples, the predefined threshold may be deemed to have been exceeded when the optical property is determined to have a value that exceeds the predefined threshold. In these examples, the predefined threshold may be set based upon how different levels of the optical property correlate to conditions of the solidified build material particles 202. For instance, different optical property levels may correlate to different strength levels, quality levels, deformation levels, etc., of the solidified build material particles 202.

By way of particular example, the predefined threshold may define an optical property value that is indicative of a potential issue with respect to the solidified build material particles 202. For instance, an identified optical property that exceeds the predefined threshold may be an indication that the solidified build material particles may not have solidified as intended, e.g., with an intended strength, an intended quality, etc. In addition, the predefined threshold may indicate that the solidified build material particles 202 have been exposed to excess heat, excess moisture, excess fusing agent, and/or the like. Similarly to the predefined optical properties, the predefined threshold may differ for different types of build material particles 202. For example, certain optical properties (and/or greyscale intensities) of solidified build material particles may historically be known to correlate to defective solidifying of plastic or polymer material particles and other optical properties of solidified build material particles may historically be known to correlate to defective solidifying of metal material particles.

According to examples, the predefined optical property threshold may be identified through testing, which may include solidifying of the build material particles under various conditions, e.g., temperatures, moisture levels, etc., to determine at which conditions, the solidified build material particles 202 displayed various optical properties and/or optical property levels. The testing may be performed for various types of build material particles to determine correlations between the optical properties and the conditions under which the build material particles 202 were solidified. In addition, a user may define the predefined optical property threshold according to intended quality, strength, etc., levels and/or the predefined optical property threshold may be set according to a setting at which a 3D object is to be formed. For instance, the predefined optical property threshold may be relatively lower for a higher quality build, e.g., a production quality level build, and may be relatively higher for a lower quality build, e.g., a draft build quality.

The processor 102 may fetch, decode, and execute the machine-readable instructions 118 to, based on a determination that the identified optical property exceeds the predefined threshold, output an indication that the layer includes an optical property that exceeds the predefined threshold. That is, for instance, the processor 102 may output the indication based on a determination by the processor 102 that the optical property is identified in the stereoscopic 3D image 214 of the layer 206. In other examples, the processor 102 may output the indication based on a determination by the processor 102 that the identified optical property exceeds the predefined threshold.

In any regard, the processor 102 may output the indication as a message displayed on a display device. The processor 102 may additionally or alternatively output the indication as an audible message or alert, a text message, an email message, and/or the like.

In other examples, instead of the memory 110, the apparatus 100 may include hardware logic blocks that may perform functions similar to the instructions 112-118. In yet other examples, the apparatus 100 may include a combination of instructions and hardware logic blocks to implement or execute functions corresponding to the instructions 112-118. In any of these examples, the processor 102 may implement the hardware logic blocks and/or execute the instructions 112-118. As discussed herein, the apparatus 100 may also include additional instructions and/or hardware logic blocks such that the processor 102 may execute operations in addition to or in place of those discussed above with respect to FIG. 1.

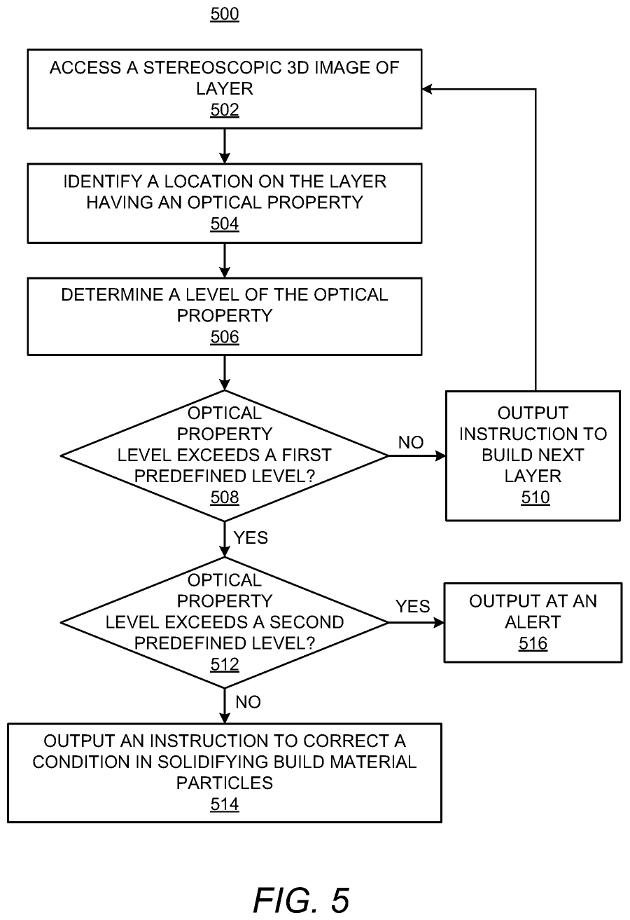

Various manners in which the processor 102 may operate are discussed in greater detail with respect to the methods 400 and 500 depicted in FIGS. 4 and 5. Particularly, FIGS. 4 and 5, respectively, depict flow diagrams of example methods 400, 500 for outputting at least one of an alert or an instruction to correct a condition in solidifying build material particles 202. It should be understood that the methods 400 and 500 depicted in FIGS. 4 and 5 may include additional operations and that some of the operations described therein may be removed and/or modified without departing from the scopes of the methods 400 and 500. The descriptions of the methods 400 and 500 are made with reference to the features depicted in FIGS. 1-3 for purposes of illustration.

At block 402, the processor 102 may access a stereoscopic 3D image 214 of a layer 206 of solidified build material particles 202. As discussed herein, the stereoscopic 3D image 214 may be generated from a pair of offset images 212 of the layer 206.

At block 404, the processor 102 may identify a location 306 on the layer 206 of the solidified build material particles 202 having an optical property, e.g., an unintended optical property, from the stereoscopic 3D image 214. For instance, the processor 102 may analyze the stereoscopic 3D image 214 to identify whether the layer 206 includes any location having the optical property, e.g., whether build material particles 202 on the layer 206 include an optical property that matches a predefined optical property. The optical property may include, for instance, a color, a transparency, a brightness, a glossiness, and/or the like. In addition, the processor 202 may identify the location 306 as a set of coordinates, e.g., using a Cartesian coordinate system or other coordinate system.

At block 406, the processor 102 may determine whether the identified optical property exceeds a predefined optical property threshold. As discussed herein, this condition may be met through identification of the optical property itself. For instance, this condition may be met when a particular color is identified in the stereoscopic 3D image 214. In other examples, this condition may be met when a value of the optical property is outside of a predefined threshold range. The predefined threshold range may include a range of optical property values that correspond to intended conditions of solidified build material particles 202. That is, for instance, the predefined threshold range may include a range of optical property values that correspond to solidified build material particles 202 having intended strength levels, intended quality levels, intended visual conditions, or the like. Thus, an optical property value that exceeds or falls below the predefined threshold range may be indicative of the solidified build material particles 202 having unintended conditions, e.g., less than desired quality levels. The predefined threshold range may be set based on historically known optical property values for a given type of build material particles, e.g., through testing and/or from real-world results, and may thus differ for different types of build material particles as well as for different types of solidifying operations.

Based on a determination that the identified optical property is within the predefined threshold range at block 406, which may also be indicative of the optical property not being identified in the stereoscopic 3D image 214 of the layer 304, the processor 102 may output an instruction to build a next layer at block 408. That is, for instance, the processor 102 may have determined from the stereoscopic 3D image 214 that the build material particles 202 in the layer 206 may have been selectively solidified as intended and thus, the next layer 206 of build material particles 202 may selectively be solidified together under the same or similar conditions as the current layer 206 of build material particles 202. That is, the processor 102 may continue to operate the forming components 220 to selectively solidify build material particles 202 in a next layer 206 under similar or the same conditions under which the build material particles 202 in the current layer 206 were solidified. The processor 102 may also repeat blocks 402-408 for the next layer 206.

However, at block 410, based on a determination that the identified optical property is outside of the predefined threshold at block 406, the processor 102 may determine a height of the solidified build material particles 202 at the location 306 on the layer 206 from the stereoscopic 3D image 214. For instance, the processor 102 may determine the heights of various locations of the layer 206 from the stereoscopic 3D image 214.

At block 412, the processor 102 may determine a probable cause (which may also be construed as a probable reason, a likely cause, a likely reason, or the like) for the optical property occurring on the build material particles 202 at the location 306. That is, the processor 102 may determine the probable cause of the optical property from at least one of a value of the optical property or the determined height of the build material particles 202 at the location 306. By way of example, the processor 102 may determine the probable cause based on a color, a brightness, a transparency level, or the like, of the build material particles 202 having the optical property. As various optical properties, such as discoloration, may occur for a variety of reasons, both systematic and anomalous, the processor 102 may use relative height information of the build material particles 202 as the missing piece of a puzzle that allows the processor 102 to determine the probable cause of the build material particles 202 having the optical property. For instance, the surface height of build material particles 202 may be the distinguishing feature between a failure to dispense a liquid fusing agent (e.g., black) at specific locations or loose powder particles (e.g., white) landing on the fused surface.

For instance, when the build material particles 202 of a particular type of material are solidified, e.g., fused, in the presence of a greater than some level of oxygen and/or water, the build material particles 202 may have a particular optical property, e.g., may turn a particular color. Likewise, when the build material particles 202 of a particular type of material are solidified in the presence of a lesser than some level of oxygen or water, the build material particles 202 may have another particular optical property, e.g., may turn another particular color. As another example, when the build material particles 202 undergo fusing in the presence of a greater than some level of heat, the build material particles 202 may have a particular optical property, e.g., may turn a particular color. Likewise, the build material particles may have another particular optical property, e.g., may turn a different color, when the build material particles 202 undergo fusing in the presence of lesser than some level of heat.

In addition or alternatively, the height of the build material particles 202 at the location 306 having the identified optical property may be indicative of some condition in which the build material particles 202 were solidified. For instance, the height of the build material particles 202 may be indicative of an oxygen level, a moisture level, a temperature, or other condition under which the build material particles 202 were solidified.

At block 414, the processor 102 may output at least one of an alert or an instruction to correct a condition in solidifying build material particles 202 in a future layer based on the determined probable cause of the optical property. Particularly, the processor 102 may output an alert to notify an operator of the determined probable cause for the optical property. In some cases, the alert may indicate that the current layer 206 may not be of acceptable quality. The processor 102 may output the alert as a message on a display device, as a text message, as an email message, or the like. In addition or alternatively, the processor 102 may output an instruction that is to cause a correction to be applied in solidifying the build material particles 202 in a future layer, e.g., a next layer. The correction may be a change to a solidifying operation of the build material particles 202 in the future layer to, for instance, reduce or eliminate the determined probable cause for the build material particles 202 in the location 306 to have the identified optical property.

According to examples, the processor 202 may determine the correction that is to be applied. The determined correction may include, for instance, varying the oxygen level in the build zone 228, varying the amount of binding agent or fusing agent applied, varying the amount of energy applied to fuse the build material particles 202, or the like. For instance, oxygen may be supplied in the build zone 228 from an oxygen source (not shown) and the oxygen level may be varied by varying a concentration of oxygen supplied into the build zone 228 from the oxygen source. The processor 202 may inform an operator of the determined correction and/or may control the forming components 220 to vary the solidifying operation according to the determined correction that is to be applied. In other examples, the processor 202 may instruct another processor or computing device to make the correction determination.

Following block 414, the processor 102 may receive instructions from an operator, may continue forming of a 3D object, or the like. In addition, the processor 102 may continue to execute the method 400 as portions of the 3D object are formed in subsequent layers of build material particles 202. Through implementation of the method 400, the processor 102 may control the quality of a 3D object build in real time layer-by-layer.

With reference now to FIG. 5, at block 502, the processor 102 may access a stereoscopic 3D image 214 of a layer 304 of build material particles 202. The processor 102 may access the stereoscopic 3D image 214 as discussed above with respect to block 402. In addition, the processor 102 may identify a location 306 on the layer 304 having an optical property as discussed above with respect to block 404.

At block 506, the processor 102 may determine a level of the optical property. For instance, the processor 102 may determine a color of the optical property, a greyscale level of the optical property, a brightness level of the optical property, a glossiness level of the optical property, a transparency level of the optical property, or the like.

At block 508, the processor 102 may determine whether the determined optical property level exceeds a first predefined level. The first predefined level may be a first predefined threshold corresponding to a first build quality level, a first build strength level, or the like. According to examples, the first predefined level may be determined and based upon testing and/or from real-world results. In any regard, based on a determination that the optical property does not exceed the first predefined level at block 508, the processor 102 may output an instruction to build a future layer 206, e.g., a next layer, using the same or similar solidifying operations as the current layer. That is, the processor 102 may continue to operate the forming components 220 to selectively solidify build material particles 202 in a future layer 206 under the same or similar conditions as were used to solidify the build material particles 202 in the current layer 306. The processor 102 may also repeat blocks 502-510 for the future layer.

However, based on a determination that the optical property does exceed the first predefined level, the processor 102 may determine whether the optical property exceeds a second predefined level at block 512. The second predefined level may be a second predefined threshold corresponding to a second build quality level, a second build strength level, or the like, that is higher than the first predefined level. Based on a determination that the optical property does not exceed the second predefined level at block 512, the processor 102 may output an instruction to modify a condition in solidifying build material particles 202 in a future layer at block 514. Block 514 may be similar to block 414 in FIG. 4. According to examples, the processor 102 may output the instruction to correct the condition based on the probable cause for the optical property as discussed above with respect to block 414.

However, based on a determination that the optical property exceeds the second predefined level, the processor 102 may output an alert as discussed above with respect to block 414. That is, for instance, the processor 102 may attempt to correct the condition that caused the optical property to exist in instances in which the optical property corresponds to a relatively smaller issue, e.g., defect, build quality, etc., and may alert an operator in instances in which the optical property corresponds to a relatively larger issue. By way of particular example, the processor 102 may attempt to correct to the condition that caused the optical property to exist in instances in which the build operation of the 3D object may continue to move forward and may output the alert when there may be a sufficiently large defect to warrant possibly stopping the build operation of the 3D object.

Some or all of the operations set forth in the methods 400 and 500 may be contained as utilities, programs, or subprograms, in any desired computer accessible medium. In addition, the methods 400 and 500 may be embodied by computer programs, which may exist in a variety of forms. For example, the methods 400 and 500 may exist as machine readable instructions, including source code, object code, executable code or other formats. Any of the above may be embodied on a non-transitory computer readable storage medium.

Examples of non-transitory computer readable storage media include computer system RAM, ROM, EPROM, EEPROM, and magnetic or optical disks or tapes. It is therefore to be understood that any electronic device capable of executing the above-described functions may perform those functions enumerated above.

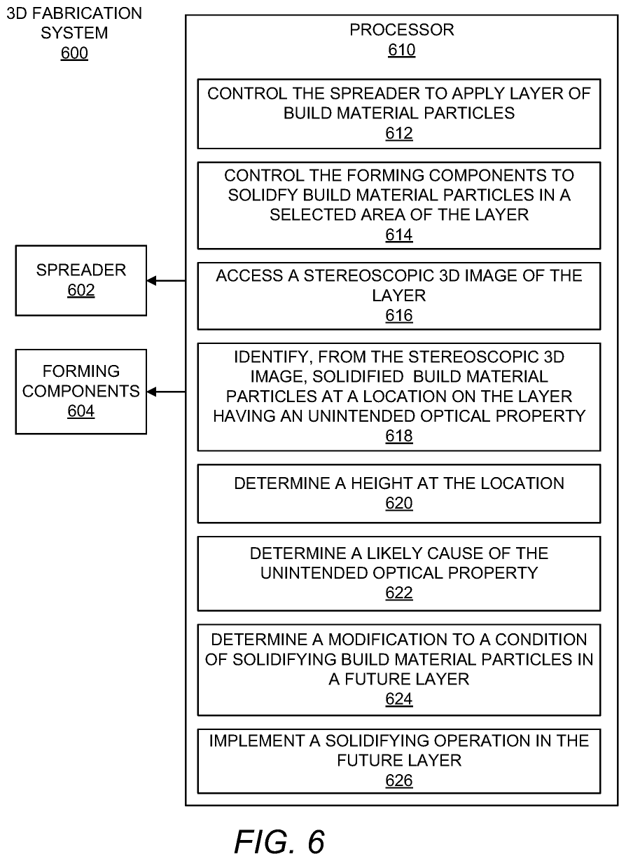

Turning now to FIG. 6, there is shown an example 3D fabrication system 600 that may be used implement either or both of the methods 400 and 500 depicted in FIGS. 4 and 5. It should be understood that the example 3D fabrication system 600 depicted in FIG. 6 may include additional features and that some of the features described herein may be removed and/or modified without departing from the scope of the 3D fabrication system 600. The description of the 3D fabrication system 600 is made with reference to FIGS. 2-5.

The 3D fabrication system 600 may include a spreader 602, which may be similar to the spreader 208 depicted in FIG. 2, forming components 604, which may be similar to the forming components 220 depicted in FIG. 2, and a processor 610, which may be similar to the processor 102 depicted in FIG. 2. The processor 610 may implement or execute a number of operations 612-626. The instructions for the operations 612-626 may be stored as machine readable instructions in a non-transitory computer readable medium and/or as hardware logic blocks.

As shown, the processor 610 may control 612 the spreader 602 to apply a layer 206 of build material particles 202 in a build zone 228. The processor 612 may control 614 the forming components 220 to solidify build material particles 202 in a selected area 226 of the layer 206. The processor 610 may access 616 a stereoscopic 3D image 214 of the layer 206 (402, 502). The processor 610 may identify 618, from the stereoscopic 3D image 214, solidified build material particles 202 at a location 306 on the layer 304 having an unintended optical property (404, 406, 504, 506). The unintended optical property may be an optical property that is outside of a predefined threshold range, e.g., a particular color, a brightness level, etc. The processor 610 may determine 620 a height of the solidified build material particles 202 at the location 306 from the stereoscopic 3D image 314 (410). The processor 610 may determine 622 a likely cause of the unintended optical property from at least one of the unintended optical property or the determined height (412). The processor 610 may determine 624 a modification to a condition of solidifying build material particles in a future layer 206 of build material particles 202 from the determined likely cause of the unintended optical property (414). The processor 610 may implement 626 a solidifying operation in the future layer 206 according to the determined modification (414, 514).

Although described specifically throughout the entirety of the instant disclosure, representative examples of the present disclosure have utility over a wide range of applications, and the above discussion is not intended and should not be construed to be limiting, but is offered as an illustrative discussion of aspects of the disclosure.

What has been described and illustrated herein is an example of the disclosure along with some of its variations. The terms, descriptions and figures used herein are set forth by way of illustration only and are not meant as limitations. Many variations are possible within the spirit and scope of the disclosure, which is intended to be defined by the following claims—and their equivalents—in which all terms are meant in their broadest reasonable sense unless otherwise indicated.

What is claimed is:

1. An apparatus comprising:
a processor; and
a memory on which are stored machine readable instructions that when executed by the processor, cause the processor to:
access a stereoscopic three-dimensional (3D) image of a layer including solidified build material particles;
identify an optical property of the solidified build material particles at a location on the layer from the stereoscopic 3D image;
determine whether the identified optical property exceeds a predefined threshold; and
based on a determination that the identified optical property exceeds the predefined threshold, output an indication that the layer includes an optical property that exceeds the predefined threshold.

2. The apparatus of claim 1, wherein the instructions are further to cause the processor to:
determine, based on the optical property, a probable reason as to why the solidified build material particles have the identified optical property.

3. The apparatus of claim 2, wherein the instructions are further to cause the processor to:
based on a determination that the probable reason as to why the solidified build material particles have the identified optical property, determine a modification to a condition of solidifying build material particles in a future layer of build material particles; and
output an instruction to implement the determined modification.

4. The apparatus of claim 3, wherein the instructions are further to cause the processor to:
determine that the probable reason as to why the solidified build material particles have the identified optical property comprises an oxygen level in a build zone at which the build material particles are solidified together, a temperature of the build material particles prior to receipt of fusing energy, a temperature of the build material particles following receipt of fusing energy, or a combination thereof.

5. The apparatus of claim 4, wherein the instructions are further to cause the processor to:
based on a determination that the probable reason as to why the solidified build material particles have the identified optical property is an oxygen level in the build zone, determine the modification to be a modification to the oxygen level in the build zone; and
based on a determination that the probable reason as to why the solidified material particles have the identified optical property is a temperature of the build material particles prior to receipt of fusing energy or a temperature of the build material particles following receipt of fusing energy, determine the modification to be a modification to a fusing energy applied to build material particles during solidifying of the build material particles.

6. The apparatus of claim 1, wherein the instructions are further to cause the processor to:
determine a height of the solidified build material particles at the location on the layer from the stereoscopic 3D image.

7. The apparatus of claim 6, wherein the instructions are further to cause the processor to:
determine a probable reason as to why the solidified build material particles at the location have the identified optical property from the determined height of the fused build material particles at the location on the layer.

8. The apparatus of claim 7, wherein the instructions are further to cause the processor to:
based on a determination that the probable reason as to why the solidified build material particles have the identified optical property, determine a modification to a condition of solidifying build material particles in a future layer of build material particles; and
output an instruction to implement the determined modification.

9. A method comprising:
accessing, by a processor, a stereoscopic three-dimensional (3D) image of a layer including solidified build material particles;
identifying, by the processor and from the stereoscopic 3D image, a location on the layer of build material particles having an optical property that is outside of a predefined threshold range;
based on the optical property at the location being outside of the predefined threshold range,
determining, by the processor, a height of the solidified build material particles at the location on the layer from the stereoscopic 3D image;
determining, by the processor, a probable cause for the optical property from at least one of a value of the optical property and the determined height of the fused material particles; and
based on the probable cause for the optical property, outputting, by the processor, at least one of an alert or an instruction to correct a condition in solidifying build material particles in a future layer.

10. The method of claim 9, further comprising:
determining the probable cause of the optical property as being one of an improper oxygen level in a build zone of a 3D printing system, the build material particles reaching an improper temperature prior to receiving fusing energy, the build material particles reaching an improper temperature following receipt of fusing energy, or a combination thereof;
determining a modification to a condition of solidifying build material particles in a future layer of build material particles; and
outputting the determined modification as the instruction to correct the condition.

11. The method of claim 10, further comprising:
based on a determination that the probable cause of the optical property is an improper oxygen level in the build zone, determining the modification to be a modification to the oxygen level in the build zone; and
based on a determination that the probable cause of the optical property is a temperature of the build material particles prior to receipt of fusing energy or a temperature of the build material particles following receipt of fusing energy, determining the modification to be a modification to a fusing energy applied to build material particles during fusing of the build material particles.

12. The method of claim 9, further comprising:
determining a level of the optical property;
based on the determined level of the optical property exceeding a first predefined level, outputting the instruction to modify a condition of a solidifying operation on a future layer; and
based on the determined level of the optical property exceeding a second predefined level, outputting the alert.

13. A three-dimensional (3D) fabrication system comprising:
a spreader;
forming components;
a processor to:
control the spreader to apply a layer of build material particles in a build zone;
control the forming components to solidify build material particles in a selected area of the layer;
access a stereoscopic 3D image of the layer;
identify, from the stereoscopic 3D image, solidified build material particles at a location on the layer having an unintended optical property;
determine a modification to a condition of solidifying build material particles in a future layer of build material particles based on the identified solidified build material particles at the location having the unintended optical property; and
implement a solidifying operation on build material particles in the future layer according to the determined modification.

14. The 3D fabrication system of claim 13, wherein the processor is further to:
determine a height of the solidified build material particles having the unintended optical property at the location from the stereoscopic 3D image; and
determine the modification to the condition of solidifying build material particles in the future layer of build material particles based on at least one of a level of the unintended optical property or the determined height of the fused build material particles at the location.

15. The 3D fabrication system of claim 13, wherein the processor is further to:
determine a likely cause of the unintended optical property; and
determine the modification based on the determined likely cause of the unintended optical property.
